(19) United States
(12) Patent Application Publication
(10) Pub. No.: US 2014/0323655 A1
(43) Pub. Date: Oct. 30, 2014

(54) HALOGEN-CONTAINING THERMOPLASTIC RESINS COMPOSITIONS

(71) Applicant: CELANESE EMULSIONS GMBH, SULZBACH (TAUNUS) (DE)

(72) Inventors: Davide Brizzolara, Frankfurt am Main (DE); Lars Koelling, Mannheim (DE)

(73) Assignee: CELANESE EMULSIONS GMBH, SULZBACH (TAUNUS) (DE)

(21) Appl. No.: 14/263,364

(22) Filed: Apr. 28, 2014

Related U.S. Application Data
(60) Provisional application No. 61/816,952, filed on Apr. 29, 2013.

(51) Int. Cl. C08L 27/06

(52) U.S. Cl. CPC C08L 27/06
USPC 525/76

(57) ABSTRACT

A halogen-containing thermoplastic resin composition comprises (i) a halogen-containing thermoplastic resin; and (ii) a graft copolymer comprising (a) a first polymer produced by emulsion polymerization of at least one vinyl ester of a C₁ to C₂₀ carboxylic acid in the presence of a nonionic surfactant and (b) a second polymer having a glass transition temperature of at least 45° C. produced by emulsion polymerization of at least one monomer in the presence of the first polymer.

### CROSS REFERENCE TO RELATED APPLICATIONS

This application claims the benefit of the filing date of U.S. Provisional Application No. 61/816,952 filed Apr. 29, 2013, the entire contents of which are incorporated herein by reference.

### FIELD

The present invention relates to halogen-containing thermoplastic resins compositions.

### BACKGROUND

Halogen-containing thermoplastic resins, represented by polyvinyl chloride (PVC) resin, are not only comparatively inexpensive but generally satisfactory in clarity, mechanical properties and processability so that they find application in a broad spectrum of products such as film, sheet, hose, flexible containers, coated cloth, leather cloth, cover sheets, tarpaulin, shoe soles, sponges, wire covering, household goods and the like.

In order to improve the moldability of the resin and the physical and/or chemical properties of the resultant product, it is common to blend PVC and other halogen-containing thermoplastic resins with a variety processing aids and product modifiers. Among the common blending components are plasticizers or flexibilizers, which are added to the resin to make it soft and flexible and to improve its flow and therefore processability, and impact modifiers, which are included to improve the impact strength and processability of rigid products. It is of course important that any given blending component not only improves the targeted property of the resin but also does not result in reduction in some other desirable attribute of the material. For example, for many applications it is important that any additive does not adversely affect the optical clarity of the product.

Suitable plasticizers for PVC include phthalate esters, such as diisononyl phthalate, diisodecyl phthalate and di(2-ethylhexyl)phthalate (dioctyl phthalate, DOP). However, such low molecular weight materials tend to have the disadvantage that they migrate over time which can cause the product to lose flexibility and become brittle.

To avoid the problems found with low molecular weight plasticizers, a variety of polymeric materials, generally called flexibilizers (Polymer Handbook, C. Daniels, Wiley), have been used to make PVC soft and flexible. Examples of such polymeric materials include copolymers of vinyl acetate, ethylene and vinyl chloride monomer (VAE-VCM), ethylene-vinyl acetate (EVA) copolymers, such as Levapren®, acrylonitrile-butadiene rubbers, copolymers of butyl acrylate, ethylene and carbon monoxide, such as Elavaloy® and acrylonitrile-butadiene-styrene (ABS) copolymers. Polymeric flexibilizers are in general non-migrating and have a good cold flexibility, but typically result in PVC products have reduced mechanical properties and transparency disadvantages as compared to products obtained with low molecular weight plasticizers.

Graft copolymers of PVC with other polymeric materials are also commercially available and include Vinnolit VK 801®, which comprises equal parts of VAE and VCM, and Vinnolit VK710®, Vinnolit K704®, Vinnolit K707E®, and Vinnolit K725 F®, which comprise equal parts of polybutylacrylate and PVC. The graft copolymers are used to improve the block resistance of rigid PVC or as flexibilizers for the production of soft PVC Films made from these PVC graft copolymers are contact transparent or translucent depending of the layer thickness. However, films made from blends of PVC with these graft copolymers are opaque.

U.S. Pat. No. 5,232,991 discloses the use of cross linked polyacrylates to improve the impact resistance of rigid PVC or to make PVC more flexible. In addition, U.S. Pat. No. 5,185,406 describes a suspension polymerization process to produce a PVC graft copolymer with an amount of 65 weight % of a vinyl acetate/ethylene copolymer or a homo- and copolymer of an acrylic acid ester. The product can be blended with PVC to improve its impact resistance or to make it flexible. However, the suspension polymerization process, particularly in combination with high amounts of polyacrylate, suffers from the problem of high viscosity and poor heat transfer during the polymerization. Moreover, films manufactured from these graft copolymers are opaque.

U.S. Pat. No. 5,030,690 discloses a halogen-containing thermoplastic resin composition comprising 100 parts by weight of a halogen-containing thermoplastic resin (A) and 1 to 100 parts by weight of a graft polymer (B) having a melt index of 1 to 15 g/10 min as determined at a temperature of 190° C. under a load of 2.16 kg and a benzene-insoluble fraction content of not more than 30 percent by weight. The polymer (B) is obtained by graft-polymerizing 100 parts by weight of suspension-polymerized ethylene-vinyl acetate copolymer having a vinyl acetate content of 50 to 90 percent by weight as a substrate with 5 to 50 parts by weight of at least one monomer which, when polymerized alone, gives a homopolymer with a glass transition temperature of 65 to 150° C. as a grafting component. Suitable hard monomers include methacrylic esters, unsaturated nitriles and styrene compounds.

Japanese Patent Application Kokai No. 61/16949 discloses a resin composition prepared by suspension-polymerizing a vinyl monomer, for example vinyl acetate, ethylene, methyl acrylate, ethyl acrylate, methyl methacrylate, acrylonitrile, etc., which has a solubility parameter of 8.5 to 15, in the presence of an emulsion-polymerized ethylene-vinyl acetate copolymer with a vinyl acetate content of 90 to 50 weight % to give a modified ethylene-vinyl acetate copolymer and, then, blending this modified copolymer with vinyl chloride resin.

U.S. Pat. No. 5,187,233 discloses a graft copolymer produced by means of emulsion polymerization. The graft base is a sulfonate group-containing vinyl ester/ethylene latex which is stabilized exclusively by an anionic emulsifier and is grafted, preferably with vinyl chloride, without further addition of emulsifier or protective colloid. The graft copolymers are reported to have good water resistance and thermoplastic processability, making them useful as impact modifiers in the production of articles, such as, soft to semi-hard PVC moldings. However, a disadvantage of the described process, which doesn't allow the use of nonionic surfactant or protective colloids, is the low stability of the latex which is a problem for commercial production.

Despite these advances, there is a continuing need to find new additive systems for rendering PVC products more flexible or, in the case of rigid products, for improving their processability and impact resistance.

### SUMMARY

According to the invention, it has now been found that by using emulsion polymerization to graft a hard polymer, such as poly(methyl methacylate), onto an emulsion polymerized vinyl ester-based substrate, it is possible to produce an exceptionally versatile blending component for halogen-containing thermoplastic resins, especially PVC. Thus, depending on the degree of cross-linking of the substrate and the amount of the resultant graft copolymer blended with the base resin, the additive can be used to render the resin more flexible and/or improve the impact resistance and processability of a rigid product. The final product also exhibits excellent optical properties for both transparent and non-transparent applications.

In one aspect, the invention resides in a halogen-containing thermoplastic resin composition comprising a blend of at least: (i) a halogen-containing thermoplastic resin; and (ii) a graft copolymer comprising

(a) a first polymer produced by emulsion polymerization of at least one vinyl ester of a C₁ to C₂₀ carboxylic acid in the presence of a nonionic surfactant; and

(b) a second polymer having a glass transition temperature of at least 45° C., preferably 65 to 150° C., produced by emulsion polymerization of at least one monomer in the presence of the first polymer.

In one embodiment, the halogen-containing thermoplastic resin comprises polyvinyl chloride and the resin composition comprises from 0.5 weight % to 80 weight % of the graft copolymer (ii).

Conveniently, the vinyl ester of a C₁ to C₂₀ carboxylic acid comprises vinyl acetate and optionally comprises ethylene. Where present, the ethylene comprises from 5 to 60 wt % of the first polymer.

In one embodiment, the graft copolymer (ii) has a weight average particle size of less than 200 nm.

In one embodiment, the at least one monomer comprises an ester of methacrylic acid and a C₁ to C₁₀ alcohol, for example methyl methacrylate, ethyl methacrylate, isopropyl methacrylate, butyl methacrylate, phenyl methacrylate and mixtures thereof, preferably methyl methacrylate. Generally, the second polymer (b) comprises at least 60 wt % of said methacrylic ester.

In one embodiment, at least the first polymer (a) comprises up to 5 wt % of a cross-linking monomer.

In a further aspect, the invention resides in the use of the graft copolymer described herein as a flexibilizer and/or an impact modifier for a halogen-containing thermoplastic resin, such as PVC.

### DETAILED DESCRIPTION

As used herein, the term “polymer” is intended to include not only homopolymers of a single monomer but also copolymers and interpolymers of two or more different monomers.

Glass transition temperature, Tg, values cited herein are determined by differential scanning calorimetry as described in the Examples.

The present application describes a class of graft copolymers which exhibit improved properties as flexibilizers and/or impact modifiers for halogen-containing thermoplastic resins, especially PVC. The modifying properties of the graft copolymers depend on the formulation and concentration in the resin composition.

The present graft copolymers comprise a graft substrate in the form of an emulsion polymerized first polymer comprising a vinyl ester of a C₁ to C₂₀ carboxylic acid. Grafted onto the first polymer substrate is second polymer produced by emulsion polymerization, in the presence of the first polymer, of at least one monomer which, when polymerized alone, gives a homopolymer with a glass transition temperature of at least 45° C., preferably 65 to 150° C.

Any vinyl ester of a C₁ to C₂₀ carboxylic acid can be used in the production of the first polymer substrate including vinyl acetate, vinyl propionate, vinyl laurate, vinyl stearate, and Versatic acid vinyl esters, with vinyl acetate being particularly preferred.

The first polymer may be a homopolymer of the above vinyl ester but more generally will be a copolymer or interpolymer of the vinyl ester as base monomer with one or more different comomoners. One suitable comonomer comprises a C₂-C₈ aliphatic hydrocarbon with 1 or 2 olefinic double bonds. Examples of suitable C₂-C₈ aliphatic hydrocarbons with one olefinic double bond include, for example, ethylene and propylene, whereas representative examples of C₂-C₈ aliphatic hydrocarbons having two olefinic double bonds include butadiene, isoprene and chloroprene. The preferred unsaturated aliphatic hydrocarbon is ethylene, which may be present in the first polymer in an amount from 5 to 60 wt %, such as from 10 weight % to 40 weight %, of the first polymer.

In addition, to the main monomers referred to above, the first polymer may contain up to 10 wt %, such as from about 0.5 to 5 wt %, of at least one auxiliary monomer comprising at least one of an ethylenically unsaturated carboxylic acid or an anhydride or amide thereof, an ethylenically unsaturated sulfonic acid, or an ethylenically unsaturated phosphonic acid.

For example, the auxiliary monomer may comprise an ethylenically unsaturated C₃-C₈ monocarboxylic acid and/or an ethylenically unsaturated C₄-C₈ dicarboxylic acids, together with the anhydrides or amides thereof. Examples of suitable ethylenically unsaturated C₃-C₈ monocarboxylic acids include acrylic acid, methacrylic acid and crotonic acid, together with their amides, such as acrylamide and methacrylamide. Examples of suitable ethylenically unsaturated C₄-C₈ dicarboxylic acids include maleic acid, fumaric acid, itaconic acid and citraconic acid.

Examples of suitable ethylenically unsaturated sulfonic acids include those having 2-8 carbon atoms, such as vinylsulfonic acid, 2-acrylamido-2-methylpropanesulfonic acid, 2-acryloyloxyethanesulfonic acid and 2-methacryloyloxyethanesulfonic acid, 2-acryloyloxy- and 3-methacryloyloxypropanesulfonic acid. Examples of suitable ethylenically unsaturated phosphonic acids also include those having 2-8 carbon atoms, such as vinylphosphonic acid and ethylenically unsaturated polyethoxyalkyletherphosphates.

In addition to or instead of said acids, it is also possible to use the salts thereof, preferably the alkali metal or ammonium salts thereof, particularly preferably the sodium salts thereof, such as, for example, the sodium salts of vinylsulfonic acid and of 2-acrylamidopropanesulfonic acid.

Depending on the desired end use of the graft copolymer, the first polymer may also contain up to 5 wt %, typically from 0.25 weight % to 3 weight %, of at least one radically polymerizable cross-linking comonomer. For example, if the graft copolymer is intended for use as a flexibilizer for PVC, it may be preferred to use zero to less than 1 weight % of a cross-linking comonomer, whereas if the graft copolymer is intended for use as an impact modifier for PVC, it may be preferred to use at least 0.5 weight % of a cross-linking comonomer.

Suitable cross-linking comonomers include compounds having 2 or more olefinic double bonds, such as triallyl cyanurate, triallyl isocyanurate, diallyl maleate, diallyl fumarate, divinyl benzene, diallyl phthalate, and glycidyl methacrylate (GMA). Other suitable cross-linking co-monomers include unsaturated compounds that contain two or more carbonyl moieties. Examples of such suitable co-monomers include diacetone acrylamide (DiAAA), polymerizable 1,3-dicarbonyl compounds and polymerizable 1,3-diketoamides. Suitable polymerizable 1,3-dicarbonyl compounds include acetoacetoxyethyl acrylate, acetoacetoxyethyl methacrylate (AEEM), acetoacetoxypropyl methacrylate, acetoacetoxybutyl methacrylate, 2,3-di(acetoacetoxy)propyl methacrylate and allyl acetoacetate. Suitable polymerizable 1,3-diketoamides include those compounds described in U.S. Pat. No. 5,889,098, which patent is incorporated herein by reference. Examples of compounds of this type include amido acetoacetonates such as 3-isopropenyl-α,α-dimethylbenzyl amidoacetoacetate, 4-isopropenyl-α,α-dimethylbenzyl amidoacetoacetate, 4-ethylenyl-phenyl amidoacetoacetate and the like.

In some embodiments, the cross-linking comonomer can include an unsaturated silane compound of the structural Formula I:

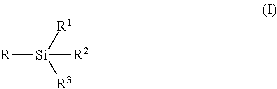

in which R denotes an organic radical olefinically unsaturated in the ω-position and R¹ R² and R³ may be identical or different, denote halogen, preferably chlorine, or the group —OZ, Z denoting hydrogen or primary or secondary alkyl or acyl radicals optionally substituted by alkoxy groups.

Suitable unsaturated silane compounds of the Formula I are preferably those in which the radical R in the formula represents an ω-unsaturated alkenyl of 2 to 10 carbon atoms, particularly of 2 to 4 carbon atoms, or an ω-unsaturated carboxylic acid ester formed from unsaturated carboxylic acids of up to 4 carbon atoms and alcohols carrying the Si group of up to 6 carbon atoms. Suitable radicals R¹, R², R³ are preferably the group —OZ, Z representing primary and/or secondary alkyl radicals of up to 10 carbon atoms, preferably up to 4 carbon atoms, or alkyl radicals substituted by alkoxy groups, preferably of up to 3 carbon atoms, or acyl radicals of up to 6 carbon atoms, preferably of up to 3 carbon atoms, or hydrogen. Most preferred unsaturated silane co-monomers are vinyl trialkoxy silanes.

Examples of preferred silane compounds of the Formula I include vinyltrichlorosilane, vinylmethyldichlorosilane, γ-methacryloxypropyltris(2-methoxyethoxy)silane, vinylmethoxysilane, vinyltrimethoxysilane, vinyltriethoxysilane, vinyldiethoxysilanol, vinylethoxysilanediol, allyltriethoxysilane, vinyltripropoxysilane, vinyltriisopropoxysilane, vinyltributoxysilane, vinyltriacetoxysilane, trimethylglycolvinylsilane, γ-methacryloxypropyltrimethylglycolsilane, γ-acryloxypropyltriethoxysilane and γ-methacryloxypropyltrimethoxysilane.

In some embodiments, the first copolymer may be formed by a multistage emulsion polymerization process in which each stage employs a different amount of comonomer(s), for example, ethylene, in addition to the vinyl ester base polymer. For example, an initial vinyl acetate/ethylene copolymer can be formed in an initial emulsion polymerization stage. Then, when the initial stage is complete, a further vinyl acetate homopolymer or copolymer with reduced ethylene content can be grafted onto the initial VAE polymer in a further emulsion polymerization stage. In this way the first polymer may have a heterogeneous composition distribution.

The present graft copolymer also includes a second polymer which has a glass transition temperature of at least 45° C., preferably 65 to 150° C. and which is grafted onto the first polymer by emulsion polymerization of at least one hard monomer. Suitable hard monomers for producing the second polymer comprise methacrylic acid esters of C₁ to C₁₀ alcohols, such as one or more of methyl methacrylate, ethyl methacrylate, isopropyl methacrylate, butyl methacrylate and phenyl methacrylate; unsaturated nitriles, such as one or more of acrylonitrile and methacrylonitrile; and styrene compounds, such as one or more of styrene and 4-methylstyrene. Preferred hard monomers are methacrylic acid esters of C₁ to C₁₀ alcohols, which may be present in an amount of at least 60 wt % of the second polymer. Soft monomers can be copolymerized with the hard monomers to an extent that the glass transition temperature of the resulting polymer lies between 45° C. and 150° C.

In addition to hard monomers, the second polymer can contain up to 10 weight %, for example from 0.1 weight % to 5 weight %, of one or more of the auxiliary comonomers described above in the relation to the first polymer and/or one or more hydroxyacrylic and hydroxymethacrylic acid esters of C₁ to C₁₀ alcohols. Such auxiliary monomers can be copolymerized with the hard monomers to the extent that the glass transition temperature of the resulting polymer lies between 45° C. and 150° C.

The second polymer may also contain up to 5 weight %, for example from 0.25 weight % to 3 weight %, of one or more cross-linking co-monomers as described above for the first polymer.

In most embodiments, the second polymer comprises at least 90 weight %, preferably at least 95 weight %, even 100 weight %, of the at least one hard monomer.

The weight ratio of the first polymer to the second polymer in the present graft copolymer is not critical but generally is from 5:95 to 95:5, preferably from 80:20 to 50:50.

The graft copolymer described herein is produced by a multi-stage polymerization process, in which each stage is conducted by free radical aqueous emulsion polymerization. Specifically, the first vinyl-ester based polymer is produced in at least one first polymerization stage and the second polymer is grafted onto the first polymer in at least one second polymerization stage.

The first polymerization stage is conducted with the required monomer(s) for the first polymer dispersed in an aqueous phase in the presence of a free radical initiator and at least one non ionic surfactant. Ionic surfactants, especially anionic surfactants, may also be present, but generally protective colloids, such as polyvinyl alcohol, are avoided or kept to low levels (less than 0.5 wt % of the monomers).

Suitable free radical initiators include hydrogen peroxide, benzoyl peroxide, cyclohexanone peroxide, isopropyl cumyl hydroperoxide, persulfates of potassium, of sodium and of ammonium, peroxides of saturated monobasic aliphatic carboxylic acids having an even number of carbon atoms and a C8-C12 chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl)hexanoyl peroxide, tert-butyl perpivalate, hydroperoxypinane, p-methane hydroperoxide. The abovementioned compounds can also be used within redox systems, using transition metal salts, such as iron(II) salts, or other reducing agents. Alkali metal salts of oxymethanesulfinic acid, hydroxylamine salts, sodium dialkyldithiocarbamate, sodium bisulfite, ammonium bisulfite, sodium dithionite, diisopropyl xanthogen disulfide, ascorbic acid, tartaric acid, and isoascorbic acid can also be used as reducing agents.

Suitable nonionic surfactants for use in the first polymerization stage include acyl, alkyl, oleyl and alkylaryl ethoxylates. Examples include ethoxylated mono-, di- and trialkylphenols (EO: from 3 to 50, alkyl substituted radical: C₄ to C₁₂) and ethoxylated fatty alcohols (EO: from 3 to 80; alkyl radical: C₈ to C₃₆), especially C₁₂-C₁₄-fatty alcohol (3-8) ethoxylates, C₁₃-C₁₅-oxo alcohol (3-30) ethoxylates, C₁₆-C₁₈-fatty alcohol (11-80) ethoxylates, C₁₋₁₀-oxo alcohol (3-11) ethoxylates, C₁₋₃-oxo alcohol (3-20) ethoxylates, polyoxyethylene sorbitanmonooleate with 20 ethylene oxide groups, copolymers of ethylene oxide and propylene oxide with a minimum content of 10% by weight of ethylene oxide, the polyethylene oxide (4-20) ethers of oleyl alcohol and the polyethylene oxide (4-20) ethers of nonylphenol. Particularly suitable are the polyethylene oxide (4-20) ethers of fatty alcohols, especially of oleyl alcohol. It is also possible to use mixtures of nonionic surfactants.

The amount of nonionic surfactant employed in the first polymerization stage is typically from 0.05 to 10 parts by weight, preferably from 0.5 to 7.0 parts by weight, more preferably from 0.5 to 5 parts by weight and most preferably from 1.0 to 3.5 part by weight, based on the total amount of monomers used.

Suitable ionic surfactants include sodium, potassium and ammonium salts of straight-chain aliphatic carboxylic acids of chain length C₁₂-C₂₀, sodium hydroxyoctadecanesulfonate, sodium, potassium and ammonium salts of hydroxy fatty acids of chain length C₁₂-C₂₀ and their sulfation and/or acetylation products thereof, alkyl sulfates, also in the form of triethanolamine salts, alkyl-(C₁₀-C₂₀)-sulfonates, alkyl(C₁₀-C₂₀)-arylsulfonates, dimethyldialkyl-(C₈-C₁₈)-ammonium chloride, and sulfation products thereof, alkali metal salts of sulfosuccinic esters with aliphatic saturated monohydric alcohols of chain length C₄-C₁₆, sulfosuccinic 4-esters with polyethylene glycol ethers of monohydric aliphatic alcohols of chain length C₁₀-C₁₂ (disodium salt), sulfosuccinic 4-esters with polyethylene glycol nonylphenyl ether (disodium salt), sulfosuccinic acid biscyclohexyl ester (sodium salt), lignosulfonic acid and the calcium, magnesium, sodium and ammonium salts thereof, resin acids, hydrogenated and dehydrogenated resin acids and alkali metal salts thereof, sodium (dodecylated diphenyl ether) disulfonate and sodium laurylsulfate, or ethoxylated sodium lauryl ether sulfate (3 EO).

When anionic emulsifiers are used, the amount thereof, based on the total amount of monomers used, is typically from 0.05 to 10 parts by weight, preferably from 0.05 to 5.0 parts by weight, more preferably from 0.05 to 3.65 parts by weight and most preferably from 0.5 to 2 part by weight. It is also possible to use mixtures of ionic surfactants.

Mixed surfactant systems can also be employed and in one preferred embodiment the surfactant system comprises a mixture of 1 weight % to 5 weight % of an ionic surfactant with from 0.5 weight % to 2 weight % of an ethoxylated nonionic surfactant with EO content >9 mol.

The polymerization reaction to produce the first polymer may be carried out in one, two or more steps using any known polymerization reactor system, such as a batch, loop, continuous, or cascade reactor system.

The temperature in the first polymerization stage generally ranges from about 20° C. to about 150° C., more preferably from about 50° C. to about 120° C. The polymerization generally takes place under pressure if appropriate, preferably from about 2 to about 150 bar, more preferably from about 5 to about 100 bar.

In a typical polymerization procedure, the vinyl acetate, ethylene, and any other co-monomers can be polymerized in an aqueous medium under pressures up to about 120 bar in the presence the specified surfactant stabilizers and initiators. The aqueous reaction mixture in the polymerization vessel can be maintained by a suitable buffering agent at a pH of about 2 to about 8.

The manner of combining the several ingredients employed in the first polymerization stage, i.e., stabilizing system, co-monomers, initiator system components, etc., can vary widely. Generally an aqueous medium containing at least part of the stabilizing system can be initially formed in a polymerization vessel with the various other polymerization ingredients being added to the vessel thereafter.

Co-monomers can be added to the polymerization vessel continuously, incrementally or as a single charge addition of the entire amounts of co-monomers to be used. Co-monomers can be employed as pure monomers or can be used in the form of a pre-mixed emulsion. When present, ethylene as a co-monomer can be pumped into the polymerization vessel and maintained under appropriate pressure therein.

It is possible for the total amount of redox initiator system to be included in the initial charge to the reactor at the beginning of the first stage polymerization. Preferably, however, a portion of the initiator is included in the initial charge at the beginning, and the remainder is added after the polymerization has been initiated, in one or more steps or continuously.

To produce the second polymer, the entire amount of the monomers required to produce the second polymer can be added in pure form, in the form of a solution or in the form of a monomer emulsion to the polymerization mixture obtained in the first stage. In this step too, the monomers can be metered in either together or in separate feeds. The duration for the addition varies typically within the range from 5 to 240 minutes, preferably from 60 to 120 minutes.

The emulsion polymerization of the second stage can be performed with or without a pre-emulsion, preferably without a pre-emulsion.

Preferably, the second stage polymerization is conducted in the presence of an ionic surfactant, such as those listed above. In the second stage, further ionic surfactant can be initially charged completely at the start of the second stage or during the second stage, can be initially charged in part and metered in part, or can be metered in completely during the performance of the second stage.

After the addition of the monomers for the second polymer, the second stage polymerization can be commenced by adding the initiator. It is assumed that the monomers supplied in the second stage can be distributed in or on the polymer particles formed in the first stage during the performance of the second stage and within any rest phase which follows.

To restart the polymerization in the second stage of the process, the initiators of free-radical polymerization known per se can be used. Examples thereof are listed above in the description of the first stage.

In this case too, the initiator for the polymerization in the second stage can be added completely to the reaction mixture at the start of the second stage or can be added in part and metered in part in the course of the second stage or can be metered in completely during the performance of the second stage.

The polymerization temperature during the second stage varies typically within the range from 20 to 120° C., preferably within the range from 30 to 110° C. and most preferably within the range from 45 to 95° C.

On completion of polymerization in the second stage, a demonomerization process, preferably by chemical after-treatment, especially with redox catalysts, for example combinations of the abovementioned oxidizing agents and reducing agents, may follow to reduce the level of residual monomers in the second stage product. In addition, residual monomers present can be removed in other known ways, for example by physical demonomerization, i.e. distillative removal, especially by means of steam distillation, or by stripping with an inert gas. A particularly efficient combination is one of physical and chemical methods, which permits lowering of the residual monomers to very low contents (<1000 ppm, preferably <100 ppm).

The product of the second polymerization stage is the desired graft copolymer in the form of an aqueous dispersion, typically having a solids contents from 20 to 70% by weight, preferably from 30 to 65% by weight and more preferably from 40 to 60% by weight, and a pH between 2 and 7, preferably between 2.5 and 6. The weight average particle size of the graft copolymer is generally less than 200 nm, for example less than 150 nm, preferably from 90 to 130, as measured by laser diffraction. The resultant dispersion has excellent shear stability.

Generally, most or all of the aqueous phase of the product dispersion is removed before the graft copolymer is blended with a halogen-containing thermoplastic resin, such as PVC. The blending can be conducted in any known mixer to produce a halogen-containing thermoplastic resin composition comprising from 0.5 weight % to 80 weight %, of the graft polymer. In practice, the actual amount of graft copolymer included in the blend depends on the intended properties of the final product. Thus, for rigid products, the blend preferably contains from 0.5 weight % to 10 weight % of the graft copolymer whereas, for flexible products, the blend normally contains from 20 weight % to 60 weight % of the graft copolymer. The resin composition may also contain other additives such as a dye or pigment, filler, lubricant, antistatic agent, antitack agent, surfactant, chelating agent, reinforcing material, stabilizer, auxiliary stabilizer, antioxidant, ultraviolet absorber, flame retardant, foaming agent and so on.

Depending on the degree of cross-linking of the first polymer and the second polymer and the amount of graft copolymer blended with the halogen-containing thermoplastic resin, it is found that the resultant product of the blend has improved flexibility, tensile strength and elongation and/or can be better processed into a rigid product of improved impact resistance. The final product also exhibits excellent optical properties for both transparent and non-transparent applications.

The invention will now be more particularly described with reference to the following non-limiting Examples.

In the Examples the following test methods are employed:

### Copolymer Dispersion Particle Size Determination

The size of solid particles within the copolymer dispersions used herein can be determined by Laser Diffraction Particle Size Analysis. The measurement is according to ISO 13320 carried out by means of a Beckman Coulter LS 13320 (Laser: 5 mW, 750 nm, PIDS Light source: 10 W) machine.

### Copolymer Glass Transition Temperature (Tg) Determination

The glass transition temperatures, Tg, referred to herein are obtained using a commercial differential scanning calorimeter Mettler DSC 820 at 10° K/min. For evaluation, the second heating curve is used and the DIN midpoint calculated.

### Solids Content Determination of Copolymer Dispersions or Coating Compositions

Solids content is measured by drying 1 to 2 grams of the aqueous dispersion or coating composition at 105° C. for 4 hours, and by then dividing the weight of dried polymer by the weight of dispersion or composition.

### Example 1

### Preparation of VAE Base Copolymer

A 30 liter pressure reactor with cooling jacket and equipped with an anchor stirrer was charged with 11169.8 g distilled water, 1058.7 g Emulsogen SDS 15 (15% concentration) ionic surfactant, 10.6 g sodium bisulfite, 10.6 g sodium carbonate, 75.6 g Emulsogen EPN 287 (70% concentration) non-ionic surfactant, 2.6 g ferric chloride, 352.9 g sodium vinyl sulfonate (30% concentration) and 1058.7 g vinyl acetate. 4235.0 g of ethylene were passed into the reactor with a maximum pressure of 85 bar and in parallel the batch was heated to 75° C. When the temperature reached 55° C., a feed of 1429.3 g of a sodium persulfate solution (7.6% concentration) was slowly added to the reactor over a period of 4.5 hours. When the temperature reached 65° C., 5293 g of vinyl acetate and 79.4 g diallylphthalate were slowly added to the reactor over a period of 4 hours. After completion of the monomer slow addition the reactor temperature was set to 80° C. The batch was cooled after completion of the slow additions and the reactor pressure was reduced to below 20 bar.

The resultant VAE copolymer dispersion exhibits a solids content of 44.1% and a pH of 3.3. The number average, dn, and the weight average, dw, particle sizes were determined by laser diffraction with a Beckman Coulter analyzer to be dn=0.08 μm and dw=0.1 μm. Using Differential Scanning calorimetry, glass transition temperature midpoints at −25° C. and 76° C. were detected.

### Example 2

### Preparation of VAE Base Copolymer

A 30 liter pressure reactor with cooling jacket and equipped with an anchor stirrer was charged with 11210.1 g distilled water, 1049.6 g Emulsogen SDS 15 (15% concentration), 10.5 g sodium bisulfite, 10.5 g sodium carbonate, 74.98 g Emulsogen EPN 287 (70% concentration), 2.6 g ferric chloride, 349.9 g sodium vinyl sulfonate (30% concentration) and 1049.6 g vinyl acetate. 4198.6 g of ethylene were passed into the reactor with a maximum pressure of 85 bar and in parallel the batch was heated to 75° C. When the temperature reached 55° C., a feed of 131.0 g of a sodium persulfate solution (7.6% concentration) was slowly added to the reactor over a period of 4.5 hours. When the temperature reached 65° C., 5248.2 g vinyl acetate and 157.4 g diallylphthalate were slowly added to the reactor over a period of 4 hours. After completion of the monomer slow addition the reactor temperature was set to 80° C. The batch was cooled after completion of the slow additions and the reactor pressure was reduced below 20 bar.

The resultant VAE copolymer dispersion exhibits a solid contents of 48.6% and a pH of 4.7. The number average, dn, and the weight average, dw, particle sizes were determined by laser diffraction with a Beckman Coulter analyzer to be dn=0.12 μm and dw=0.14 μm. Using Differential Scanning calorimetry, glass transition temperature midpoints at −23° C. and 97° C. were detected.

### Example 3

### Preparation of VAE-g-MMA Copolymer

A 30 liter pressure reactor with cooling jacket and equipped with an anchor stirrer was charged with 4720.9 g distilled water, 410.51 g Emulsogen SDS 15 (15% concentration), 5.13 g sodium acetate, 0.51 g Agitan 292 and 13035.93 g VAE copolymer dispersion of Example 1. The reactor temperature was raised to 80° C. When the reactor temperature reached 70° C., 22.1 g sodium persulfate solution (7.0% concentration) were added followed, after 10 min, by the slow addition of 4618.27 g methyl methacrylate and 23.09 g diallylphthalate over a period of 90 min. When the temperature reached 80° C., the addition of 198.6 g sodium persulfate solution (7.0% concentration) over 120 min was started. After completion of the persulfate addition, the reactor temperature of 80° C. was held for another 30 min. before cooling.

The resultant VAE-g-MMA graft copolymer comprises a VAE core comprising 40 parts by weight ethylene based on VAE, cross linked with 0.75 parts by weight diallylphthalate based on VAE. The MMA graft shell is cross linked with 0.5 parts by weight diallylphthalate based on MMA. The weight ratio VAE to MMA is 55 to 45.

The copolymer dispersion exhibits a solid content of 44.7% and a pH of 4.3. The number average, dn, and the weight average, dw, particle sizes were determined by laser diffraction with a Beckman Coulter analyzer to be dn=0.08 μm and dw=0.10 μm. Using Differential Scanning calorimetry, glass transition temperature midpoints at 25° C. and 79° C. were detected.

### Example 4

### Preparation of VAE-g-MMA Copolymer

A 30 liter pressure reactor with cooling jacket and equipped with an anchor stirrer was charged with 4587.59 g distilled water, 398.92 g Emulsogen SDS 15 (15% concentration), 4.99 g sodium acetate, 0.50 g Agitan 292 and 13819.43 g of the VAE copolymer dispersion of Example 2. The reactor temperature was raised to 80° C. When the reactor temperature reached 70° C., 21.44 g sodium persulfate solution (7.0% concentration) were added followed, in 10 min, by the slow the addition of 3989.21 g methyl methacrylate and 19.95 g diallylphthalate over a period of 90 min. When the reactor temperature reached 80° C., the addition of 192.98 g sodium persulfate solution (7.0% concentration) over 120 min was started. After completion of the persulfate addition, the reactor temperature of 80° C. was held for another 30 min before cooling.

The resultant VAE-g-MMA graft copolymer comprises a VAE core comprising 40 parts by weight ethylene based on VAE, cross linked with 1.5 parts by weight diallylphthalate based on VAE. The MMA graft shell is cross linked with 0.5 parts by weight diallylphthalate based on MMA. The weight ratio VAE to MMA is 60 to 40.

The copolymer dispersion exhibits a solid content of 52.2% and a pH of 3.3. The number average, dn, and the weight average, dw, particle sizes were determined by laser diffraction with a Beckman Coulter analyzer to be dn=0.14 μm and dw=0.16 μm. Using Differential Scanning calorimetry, one glass transition point at 25° C. was detected. A second glass transition point was not detected.

### Comparative Example 1

### Preparation of VAE Base Copolymer

A VAE graft base was polymerized in the same way as in Example 2, but without the addition of the nonionic surfactant Emulsogen EPN 287. The VAE copolymer dispersion exhibits a solid content of 48.4%, pH of 4.3. The number average, dn, and the weight average, dw, particle sizes were determined by laser diffraction with a Beckman Coulter analyzer to be dn=0.08 μm and dw=0.11 μm. Using Differential Scanning calorimetry, one glass transition point at −26° C. was detected. A second glass transition point was not detected.

### Comparative Example 2

### Preparation of VAE-g-MMA Copolymer

A VAE-g-MMA copolymer was prepared in the same way as in Example 4, but using the VAE copolymer dispersion of Comparative Example 1. The resultant product exhibits a solid content of 54.2% and a pH of 4.2. The number average, dn, and the weight average, dw, particle sizes were determined by laser diffraction with a Beckman Coulter analyzer to be dn=0.08 μm and dw=0.012 μm. With Differential Scanning calorimetry one glass transition point at −27° C. A second glass transition point was not detected.

### Example 5

### Stability Testing of Copolymer Dispersions

150 ml of each of the dispersions of Example 4 and Comparative Example 2 were filtered through 150 μm filter into a metal beaker (diameter 8.5 cm). With the metal beaker securely held in place, the dispersion was stirred with a dissolver disc of 5 cm diameter for 2 min at 5000 rpm. After shearing, the dispersion was transferred into a closed container (500 ml) and allowed to sit until the foam dissipated. The dispersion passed the stability test, if it remained liquid and a film coated on a glass plate showed no evidence of grit. The dispersion failed the test, if the dispersion became solid. The results are shown in Table 1.

TABLE 1

| Sample | Shear Test Result |
|---|---|
| Example 4 | Passed the test, dispersion still liquid, no |
| | grit on a glass plate |
| Comparison | Failed the test, dispersion is solid after |
| Example 2 | shearing |

### Example 6

### PVC Formulation and Testing

Each of the copolymer dispersions of Examples 3 and 4 was coagulated by the addition of calcium chloride under intensive stirring. The precipitated agglomerates were dried in an air circulation compartment dryer at 50° C. for two days and then ground in a Retsch ZM 200 impact mill to a free flowing powder. The grain size is controlled by the mesh size of the distance sieve and the rotating velocity of the rotor. For the present powders a sieve with 250 μm mesh size was used and a rotor speed of 16000 rpm was applied. The ground powders where dried to a residual moisture content below 1.5 wt %.

The ground copolymers of Examples 3 and 4 were blended into typical organotin-stabilized PVC formulations with copolymer loadings of 8 and 80 phr as follows:

| | | |
|---|---|---|
| PVC (k = 65) | 100 | phr |
| Copolymer | 8-25 | phr |
| Baerostab OM 710M | 2 | phr |
| Loxiol G16 | 1 | phr |
| Loxiol G70S | 0.4 | phr |

In addition, for comparison purposes, similar formulations were prepared using a commercially available VAE-g-VCM copolymer, Vinnolit VK 801, in place of the copolymer of one of Examples 3 and 4.

PVC dry blends were obtained by thoroughly mixing all components in a tumbling mixer for at least 4 minutes. The dry blends were plasticized using a Haake Rheomix batch mixer at temperatures between 160° C. and 190° C. depending on the sample type at a rotational speed of 40 rpm. Sample size was 50 g per batch. Mixing time was between 5 and 7 minutes. During mixing, rotor torque was continuously monitored.

After mixing, the plasticized PVC mass was immediately compression molded into either 1 mm thick plates (for optical and stress-strain characterization) or 4 mm thick plates (for impact testing). For this, a Rucks KV 207.00 press with 219 kN down force was utilized. Pressing temperature was always chosen to be 20° C. above the mixing temperature in order to erase any thermal history of the material. The PVC mass was heated and degassed for 2 minutes, followed by a compression step into the desired shape at 200 bar for 2 minutes.

Stress-strain experiments were performed on the compression molded plates using a Lloyd Instruments LF plus at 23° C. and 50% humidity. Test samples had a cross-section of 1 mm×3 mm and were punched out of the compression molded PVC plates. The grip to grip separation was 20 mm Pulling speed was 0.25 mm/sec within the modulus regime up to a strain of 0.25% and 15 mm/sec above 0.25%. A pre-stress of 0.5 MPa was applied. Data were analyzed using the Nexygen Plus software. Moduli were determined from the slope between 0.05 and 0.25% strain. Typically, 10 specimens were measured. The results are summarized in Table 2.

Transparency and haze were determined on the 1 mm thick compression molded plates using a Gardner haze-gard dual instrument. Typically, measurements were performed and averaged at six different sample spots. The results are summarized in Table 2.

Yellowness index was measured on a Gardner TCS II in transmission mode. Yellowness Index was determined corresponding to DIN 6167. The results are again summarized in Table 2.

As shown in Table 2, all the blends of PVC with 8 and 25 phr of the VAE-g copolymer show similar performance. However, whereas the blends with the copolymers of Examples 3 and 4 show good show good transparency and haze values, blend produced using the VAE-g-VCM copolymer is opaque.

TABLE 2

| | Polymer on | Specimen | Modulus | Tensile strength at | Elongation | | | Yellowness |
|---|---|---|---|---|---|---|---|---|
| Polymer | PVC (phr) | Thickness (mm) | (MPa) | Break (MPa) | (%) | Transparency | Haze | Index |
| Example 3 | 8 | 1 | 755 | 56.1 | 200 | 63 | 24 | 46 |
| Example 3 | 25 | 1 | 639 | 46.6 | 182 | 55 | 47 | 46 |
| Example 4 | 8 | 1 | 719 | 56.8 | 201 | 65 | 28 | 45 |
| Example 4 | 25 | 1 | 693 | 39.0 | 179 | 66 | 24 | 37 |
| VAE-g-VCM | 8 | 1 | 702 | 45.9 | 192 | 53 | 91 | 31.5 |
| VAE-g-VCM | 25 | 1 | 626 | 50.9 | 299 | 43.2 | 95.7 | 34.4 |

### Example 7

### Fusion Testing of PVC Formulations

Fusion testing was conducted with the Haake Rheomix batch mixer on similar PVC formulations produced in Example 6 but without the addition of lubrication agents. The formulations had the following composition and were produced from the ground copolymers of Examples 3 and 4 as well as the comparison material, Vinnolit VK 801:

| | | |
|---|---|---|
| PVC (k = 65) | 100 | phr |
| Polymer | 8 | phr |
| Baerostab OM 710M | 2 | phr |

The fusion time was determined as the temporal distance between the first torque maximum (caused by compressing the powder) and the second torque maximum (caused by plastification of the material). The results are shown in Table 3.

TABLE 3

| | Processing Temperature | | | |
|---|---|---|---|---|
| Sample | 170 ° C. | | 180° C. | 190° C. |
| Example 3 | 81 | sec | — | — |
| Example 4 | 67 | sec | — | — |
| VAE-g-VCM | >300 | sec | 210 sec | 75 sec |

The results in Table 3 show that, at 170° C., the formulations of the invention fuse much faster than the Vinnolit VK 801 formulation, which requires a temperature of 190° C. to achieve a similar fusion time. This allows a lower processing temperature, reducing costs on energy and thermal stabilization. This offers advantages in processing speed over competitive products.

Thus the copolymer dispersions of the invention show excellent shear stability as well as good mechanical properties, short fusion times and improved transparency when blended with PVC.

1. A halogen-containing thermoplastic resin composition comprising:
(i) a halogen-containing thermoplastic resin; and
(ii) a graft copolymer comprising
(a) a first polymer produced by emulsion polymerization of at least one vinyl ester of a C₁ to C₂₀ carboxylic acid in the presence of a nonionic surfactant; and
(b) a second polymer having a glass transition temperature of at least 45° C. produced by emulsion polymerization of at least one monomer in the presence of the first polymer.

2. The composition of claim 1, wherein the halogen-containing thermoplastic resin comprises polyvinyl chloride.

3. The composition of claim 1 and comprising from 0.5 weight % to 80 weight % of the graft copolymer (ii).

4. The composition claim 1, wherein the vinyl ester of a C₁ to C₂₀ carboxylic acid comprises vinyl acetate.

5. The composition of claim 1, wherein the first polymer also comprises ethylene, preferably in an amount from 5 to 60 wt % of the first polymer.

6. The composition of claim 1, wherein the graft copolymer has a weight average particle size of less than 200 nm.

7. The composition of claim 1, wherein at least the first polymer (a) comprises up to 5 wt % of a cross-linking monomer.

8. The composition of claim 1, wherein the at least one monomer of the second polymer (b), when polymerized alone, gives a homopolymer with a glass transition temperature of 65 to 150° C.

9. The composition of claim 1, wherein the at least one monomer of the second polymer (b) comprises an ester of methacrylic acid and a C₁ to C₁₀ alcohol.

10. The composition of claim 1, wherein the second polymer (b) comprises at least 60 wt % of an ester of methacrylic acid and a C₁ to C₁₀ alcohol.

11. The composition of claim 1, wherein the at least one monomer of the second polymer (b) comprises methyl methacrylate, ethyl methacrylate, butyl methacrylate, isopropyl methacrylate, phenyl methacrylate and mixtures thereof, preferably methyl methacrylate.

12. The composition of claim 1, wherein the weight ratio of the first polymer (a) to the second polymer (b) is from 5:95 to 95:5, preferably from 80:20 to 50:50.

13. The composition of claim 1 and comprising from 0.5% to 10% of the graft copolymer based on the total weight of the halogen-containing thermoplastic resin and the graft copolymer.

14. The composition of claim 1 and comprising from 20% to 60% of the graft copolymer based on the total weight of the halogen-containing thermoplastic resin and the graft copolymer.
